(19) United States
(12) Patent Application Publication
(10) Pub. No.: US 2026/0032390 A1
(43) Pub. Date: Jan. 29, 2026

(54) Diaphragm for Speaker and Speaker Using Same

(71) Applicant: AAC Microtech (Changzhou) Co., Ltd., Changzhou City (CN)

(72) Inventors: Chao Zhang, Changzhou (CN); Yingying Wu, Changzhou (CN)

(21) Appl. No.: 19/015,684

(22) Filed: Jan. 10, 2025

Related U.S. Application Data
(63) Continuation of application No. PCT/CN2024/107201, filed on Jul. 24, 2024.

(51) Int. Cl. H04R 7/10

(52) U.S. Cl. CPC H04R 7/10; H04R 2307/023; H04R 2307/025; H04R 2307/027

(57) ABSTRACT

The present application discloses a diaphragm for a speaker, includes a main body and a conductive part disposed on the main body. The conductive part includes a base portion and a conductive material dispersed in the base portion. The conductive material accounts for 35 wt % to 95 wt % of the conductive part, and the shape of the conductive material includes at least one of spherical, flake, rod-like, and network-like, wherein the conductive material of the same shape includes at least one size. By adding conductive materials of different morphologies and controlling the sizes of the conductive materials of different shapes in the base portion, the conductivity of the conductive part can be more efficiently improved, reducing costs while making the conductivity of the conductive part more excellent, meeting the conductivity requirements of the diaphragm.

### TECHNICAL FIELD

The present application relates to the field of electroacoustic transducers, and particularly to a diaphragm for a speaker.

### BACKGROUND

In the field of speakers, the conductive part of a commonly used conductive diaphragm is mainly composed of a polymer base and a conductive material. To reduce the resistance of the conductive part and enhance its conductivity, the mass percentage of the conductive material in the polymer base is typically increased during the preparation of the diaphragm. However, increasing the mass percentage of the conductive material often reduces the toughness of the diaphragm, and the morphology of the added conductive material is usually singular, resulting in unstable conductive pathways. Increasing the mass percentage of the conductive material not only reduces the toughness of the diaphragm but also fails to effectively improve the conductivity of the conductive part, thereby increasing production costs while failing to meet the conductivity requirements of the conductive diaphragm.

Therefore, there is a need to provide a product that addresses the above issues.

### SUMMARY

An object of the present application is to provide a diaphragm for a sound-producing device with excellent conductivity. Another object of the present application is to provide a speaker using the above diaphragm.

To achieve the above purpose, the present invention provides a diaphragm for a speaker, comprising a main body and a conductive part disposed on the main body, the conductive part including a base portion and a conductive material dispersed in the base portion, wherein the conductive material accounts for 35 wt % to 95 wt % of the conductive part, and the shape of the conductive material includes at least one of flake, rod-like, or network-like, a particle size of the spherical conductive material is 0.01-20 μm, the thickness of the flake conductive material is 0.05-5 μm and the length is 0.01-20 μm, or the diameter of the rod-like conductive material is 5-100 nm and the length is 0.1-50 km; and wherein the conductive material includes at least one combination of silver with gold, gold with copper, silver with nickel, silver with vanadium, silver with indium, or silver with palladium.

In addition, the conductive material includes at least one of a metal material, a metal compound, or a carbon-based material.

In addition, the metal material includes at least one of silver, gold, copper, aluminum, nickel, vanadium, indium, or palladium.

In addition, the metal compound includes at least one of indium oxide, tin oxide, zinc oxide, or titanium nitride.

In addition, the carbon-based material includes at least one of carbon black, graphene, or carbon nanotubes.

In addition, the material of the base portion includes at least one of a thermoplastic elastomer, polyurethane, silicone rubber, acrylate rubber, ethylene acrylate rubber, nitrile rubber, or hydrogenated nitrile rubber.

In addition, the conductive part is disposed on one side of the main body or at least partially embedded in the main body.

In addition, the conductive part is coated or adhered to one side of the main body, or the conductive part and the main body are integrally injection-molded.

The present invention further provides a speaker having a diaphragm as described above.

As described in the present application, the diaphragm for a speaker includes a main body and a conductive part disposed on the main body. The conductive part includes a base portion and a conductive material dispersed in the base portion. The conductive material accounts for 35 wt % to 95 wt % of the conductive part, and the shape of the conductive material includes at least one of spherical, flake, rod-like, and network-like, wherein the conductive material of the same shape includes at least one size.

The particle size of the spherical conductive material is 0.01-20 μm, the thickness of the flake conductive material is 0.05-5 μm and the length is 0.01-20 μm, and the diameter of the rod-like conductive material is 5-100 nm and the length is 0.1-50 μm. By adding conductive materials of different morphologies and controlling the sizes of the conductive materials of different shapes in the base portion, the conductivity of the conductive part can be more efficiently improved, reducing costs while making the conductivity of the conductive part more excellent, meeting the conductivity requirements of the diaphragm.

### BRIEF DESCRIPTION OF THE DRAWINGS

In order to more clearly explain the technical solutions in the embodiments of the present application, the following will briefly introduce the drawings required in the embodiments or exemplary technical descriptions. Obviously, the drawings in the following description are only for the application. In some embodiments, for those of ordinary skill in the art, without paying any creative labor, other drawings may be obtained based on these drawings, in which:

FIG. 1 illustrates a diaphragm having a conductive part attached to one side of a main body.

FIG. 2 illustrates a diaphragm having a conductive part partially embedded in a main body.

### DETAILED DESCRIPTION OF THE EMBODIMENTS

The following will be taken in conjunction with the accompanying drawings of embodiments of the present invention, The technical scheme in the embodiment of the invention is clearly and completely described, Obviously, the described embodiments are merely part of the embodiments of the present invention, and not all embodiments are based on the embodiments of the present invention, and all other embodiments attained by those of ordinary skill in the art without inventive effort are within the scope of the present invention.

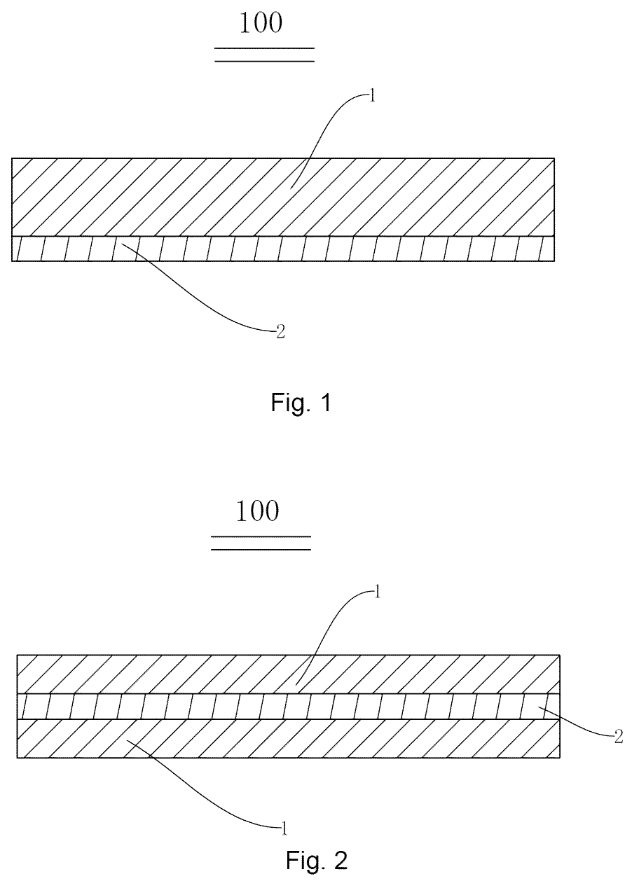

As shown in FIGS. 1-2, the present application provides a diaphragm for a speaker. The diaphragm 100 includes a main body 1 and a conductive part 2 disposed on the main body 1. The conductive part 2 includes a base portion and a conductive material dispersed in the base portion. The conductive material accounts for 35 wt % to 95 wt % of the conductive part 2, and the shape of the conductive material includes at least one of spherical, flake, rod-like, and network-like, wherein the conductive material of the same shape includes at least one size. The particle size of the spherical conductive material is 0.01-20 μm, the thickness of the flake conductive material is 0.05-5 μm and the length is 0.01-20 μm, and the diameter of the rod-like conductive material is 5-100 nm and the length is 0.1-50 μm. By adding conductive materials of different morphologies and controlling the sizes of the conductive materials of different shapes in the base portion, the conductivity of the conductive part can be more efficiently improved, reducing costs while making the conductivity of the conductive part more excellent, meeting the conductivity requirements of the diaphragm.

The present application controls the mass percentage of the conductive material in the conductive part 2 to be between 35% and 95%. For example, the mass percentage of the conductive material may be 35%, 45%, 55%, 65%, 75%, 85%, or 95%.

Further, the shape of the conductive material includes at least one of spherical, flake, rod-like, and network-like, wherein the conductive material of the same shape includes at least one size. It should be noted that the rod-like conductive material may also refer to wire-like or fiber-like, which is not limited herein.

Preferably, the conductive material includes a combination of multiple shapes such as spherical, flake, rod-like, or network-like.

Preferably, the particle size of the spherical conductive material ranges from 0.01 to 20 μm, such as 0.01 μm, 0.1 μm, 1 μm, 5 μm, 10 μm, 15 μm, or 20 μm. The spherical conductive material can be more uniformly dispersed in the base portion. The thickness of the flake conductive material is 0.05-5 μm and the length is 0.01-20 μm, such as the thickness may be 0.05 μm, 0.1 μm, 0.2 μm, 0.3 μm, 0.4 μm, or 0.5 μm, and the length may be 0.01 μm, 0.1 μm, 1 μm, 5 μm, 10 μm, 15 μm, or 20 μm. The diameter of the rod-like conductive material is 5-100 nm and the length is 0.1-50 μm, such as the diameter may be 5 nm, 10 nm, 20 nm, 50 nm, 60 nm, 80 nm, or 100 nm, and the length may be 0.1 μm, 1 μm, 10 μm, 20 μm, 30 μm, 40 μm, or 50 μm. The flake conductive material and the rod-like conductive material interweave with each other, providing a larger contact area and a more stable conductive network. The network-like conductive material provides more and more stable conductive pathways. By adding conductive materials of different morphologies and controlling the sizes of the conductive materials of different shapes in the base portion, the conductivity of the conductive part can be more efficiently improved, making the conductivity of the conductive part more excellent, meeting the conductivity requirements of the diaphragm.

Preferably, a suitable amount of nano-sized conductive material may be selectively added to the micron-sized conductive material, distributed in the gaps of the micron-sized conductive material, promoting and perfecting the conductive network through the tunneling effect, thereby efficiently improving the conductivity of the conductive part 2.

Preferably, in some embodiments, as shown in FIG. 1, the conductive part 2 may be disposed on one side of the main body 1, such as by coating or adhering the conductive part 2 to one side of the main body 1.

In other embodiments, as shown in FIG. 2, the conductive part 2 may also be at least partially embedded in the main body 1, such as by integrally injection-molding the conductive part 2 and the main body 1.

Further, the conductive material includes at least one of a metal material, a metal compound, and a carbon-based material. Preferably, the metal material includes at least one of silver, gold, copper, aluminum, and nickel. Preferably, the conductive material includes at least one combination of silver and gold, gold and copper, silver and copper, silver and nickel, silver and vanadium, silver and indium, and silver and palladium.

The metal compound includes at least one of indium oxide, tin oxide, zinc oxide, and titanium nitride. The carbon-based material includes at least one of carbon black, graphene, and carbon nanotubes. Further, the material of the base portion includes at least one of a thermoplastic elastomer, polyurethane, silicone rubber, acrylate rubber, ethylene acrylate rubber, nitrile rubber, and hydrogenated nitrile rubber.

### Example 1

The mass percentage of the conductive material in the base portion is 70%, wherein the mass percentage of the rod-like conductive material is 10%, the mass percentage of the spherical conductive material is 30%, the mass percentage of the flake conductive material is 30%, and the resistivity is 1.1e-6 Ω·m.

### Comparative Example 1

The mass percentage of the conductive material in the base portion is 70%, wherein the mass percentage of the spherical conductive material is 40%, the mass percentage of the flake conductive material is 30%, and the resistivity is 1.5e-6 Ω·m.

In Example 1, the resistivity is 1.1e-6 Ω·m, while in Comparative Example 1, the resistivity is 1.5e-6 Ω·m. Compared to Comparative Example 1, the resistivity of Example 1 is reduced by 26.7%. With the same amount of conductive material added, the conductivity is significantly improved. This demonstrates that the addition of conductive materials with different morphologies can effectively enhance the conductivity of the conductive part 2.

The present application also provides a speaker, which adopts the diaphragm described in the above example.

By controlling the mass percentage of the conductive material in the conductive part 2 within the range of 35% to 95%, and including at least one shape of the conductive material such as spherical, flake, rod-like, and network-like, wherein the conductive material of the same shape includes at least one size, the particle size of the spherical conductive material is 0.01-20 μm, the thickness of the flake conductive material is 0.05-5 μm and the length is 0.01-20 μm, and the diameter of the rod-like conductive material is 5-100 nm and the length is 0.1-50 μm, the present application achieves more efficient improvement in the conductivity of the conductive part by adding conductive materials of different morphologies and controlling the sizes of the conductive materials of different shapes in the base portion. This reduces costs while making the conductivity of the conductive part more excellent, meeting the conductivity requirements of the diaphragm.

The foregoing is merely illustrative of embodiments of the present invention, and it should be noted that modifications may be made to those skilled in the art without departing from the spirit of the invention but are intended to be within the scope of the invention.

What is claimed is:

1. A diaphragm for a speaker, comprising a main body and a conductive part disposed on the main body, the conductive part including a base portion and a conductive material dispersed in the base portion, wherein the conductive material accounts for 35 wt % to 95 wt % of the conductive part, and the shape of the conductive material includes at least one of flake, rod-like, or network-like, a particle size of the spherical conductive material is 0.01-20 μm, the thickness of the flake conductive material is 0.05-5 μm and the length is 0.01-20 μm, or the diameter of the rod-like conductive material is 5-100 nm and the length is 0.1-50 μm; and wherein the conductive material includes at least one combination of silver with gold, gold with copper, silver with nickel, silver with vanadium, silver with indium, or silver with palladium.

2. The diaphragm for a speaker as described in claim 1, wherein the conductive material includes at least one of a metal material, a metal compound, or a carbon-based material.

3. The diaphragm for a speaker as described in claim 2, wherein the metal material includes at least one of silver, gold, copper, aluminum, nickel, vanadium, indium, or palladium.

4. The diaphragm for a speaker as described in claim 2, wherein the metal compound includes at least one of indium oxide, tin oxide, zinc oxide, or titanium nitride.

5. The diaphragm for a speaker as described in claim 2, wherein the carbon-based material includes at least one of carbon black, graphene, or carbon nanotubes.

6. The diaphragm for a speaker as described in claim 1, wherein the material of the base portion includes at least one of a thermoplastic elastomer, polyurethane, silicone rubber, acrylate rubber, ethylene acrylate rubber, nitrile rubber, or hydrogenated nitrile rubber.

7. The diaphragm for a speaker as described in claim 1, wherein the conductive part is disposed on one side of the main body or at least partially embedded in the main body.

8. The diaphragm for a speaker as described in claim 1, wherein the conductive part is coated or adhered to one side of the main body, or the conductive part and the main body are integrally injection-molded.

9. A speaker having a diaphragm as described in claim 1.
